(19) United States
(12) Patent Application Publication
(10) Pub. No.: US 2007/0008441 A1
(43) Pub. Date: Jan. 11, 2007

(54) Liquid crystal display device and its driving method

(75) Inventors: Toshiaki Yoshihara, Kawasaki (JP); Tetsuya Makino, Kawasaki (JP); Shinji Tadaki, Kawasaki (JP); Hironori Shiroto, Kawasaki (JP); Yoshinori Kiyota, Kawasaki (JP); Shigeo Kasahara, Kawasaki (JP); Keiichi Betsui, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/518,563

(22) Filed: Sep. 8, 2006

Related U.S. Application Data
(63) Continuation of application No. PCT/JP04/07974, filed on Jun. 8, 2004.

(51) Int. Cl. G02F 1/1343

(52) U.S. Cl. 349/39

(57) ABSTRACT

The present invention is a liquid crystal display device having: a TFT for controlling a voltage application, correspondingly to each of a plurality of pixels; and a capacitor (storage capacitor) connected to the TFT, and after a voltage corresponding to a pixel data is applied to each pixel, one potential of the capacitor (storage capacitor) is changed. One terminal of the capacitor (storage capacitor) on an N-th line is connected to a gate line of the TFT on an (N-1)-th line. After a gate of the TFT on the N-th line is turned off, a gate voltage on the (N-1)-th line is changed.

This application is a continuation of PCT International Application No. PCT/JP2004/007974 which has an International filing date of Jun. 8, 2004 and designated the United States of America.

### TECHNICAL FIELD

The present invention relates to a liquid crystal display device and its driving method, and more particularly relates to a liquid crystal display device of an active drive type that uses a switching element, such as TFT (Thin Film Transistor) and the like, and its driving method.

### BACKGROUND ART

Along with the recent development of so-called information-oriented society, electronic apparatuses represented by a personal computer and a PDA (Personal Digital Assistant) have been widely used. With the spread of such electronic apparatuses, the demand for a portable type that can be used in offices as well as outdoors has been generated, and the smaller-size and lighter-weight thereof has been requested. As one of means to satisfy such purposes, the liquid crystal display device is widely used. The liquid crystal display device is the indispensable technique not only for the smaller size and lighter weight thereof, but also for the smaller power consumption of the portable electronic apparatus driven by a battery.

The liquid crystal display device is roughly classified into a reflection type and a transmission type. The reflection type is designed such that light-rays incident from the front of a liquid crystal panel are reflected by the rear of the liquid crystal panel, and an image is visualized through the reflected light, and the transmission type is designed such that the image is visualized through the transmitted light from a light source (back-light) placed on the rear of the liquid crystal panel. The reflection type is poor in visibility because an environmental condition causes the reflected light amount to be inconstant. Thus, in particular, as the display device of the personal computer for carrying out full-color displaying and the like, typically, the color liquid crystal display device of the transmission type which uses color filters is used.

As the color liquid crystal display device, presently, an actively-driven liquid crystal display device that uses a switching element such as TFT and the like is widely used. Although the liquid crystal display device of this TFT drive is relatively high in display quality, the light transmittance of the liquid crystal panel is low such as only several percents at present. Thus, in order to obtain a high screen brightness, the back-light of a high brightness is required. For this reason, the power consumption caused by the back-light becomes great. Moreover, this has a problem that the responsiveness to the electric field of the liquid crystal is slow, and the response speed, especially, the response speed in a half tone is slow. Also, since this is the color displaying that uses the color filters, one pixel must be composed of three sub-pixels. Also, the displaying with a high resolution is difficult, and its displayed color purity is not sufficient.

In order to solve such problems, the present inventor et al. developed a liquid crystal display device of a field-sequential type (for example, refer to non-patent documents 1, 2, 3 and the like). The liquid crystal display device of this field-sequential type does not require the sub-pixels, as compared with the liquid crystal display device of the color-filter type. Thus, the displaying with the higher resolution can be easily realized. Also, without any use of the color filters, the light emission color of a light source can be used in its original state for the displaying. Hence, this is superior in the display color purity. Moreover, since the light utilization efficiency is also high, this has a merit that the power consumption is small. However, in order to realize the liquid crystal display device of the field-sequential type, the high speed responsiveness (2 ms or less) of the liquid crystal is essential.

So, in order to attain the higher speed responsiveness of the liquid crystal display device of the field sequential type or the liquid crystal display device of the color filter type that has the foregoing excellent merits, the present inventor et al. is researching and developing the drive through a switching element, such as TFT and the like, of the liquid crystal, such as a ferroelectric liquid crystal and the like, which has a spontaneous polarization that may be expected to exhibit the speed responsiveness higher by 100 to 1000 times than that of the prior art (for example, refer to a patent document 1 and the like). In the ferroelectric liquid crystal having the spontaneous polarization, liquid crystal molecules are arranged substantially parallel to a substrate, and the long-axis direction of their liquid crystal molecules is changed by a voltage application. Then, the liquid crystal panel sandwiching the ferroelectric liquid crystal material therein is sandwiched between two polarization plates whose polarization axes are orthogonal to each other, and the birefringence caused by the change in the long-axis direction of the liquid crystal molecules is used, thereby changing the transmission light intensity.

[Patent Document 1] Japanese Patent Application Laid Open 11-119189.

[Non-Patent Document 1] T. Yoshihara et al., (ILCC 98) P1-074, edited in 1998

[Non-Patent Document 2] T. Yoshihara et al., (AM-LCD'99 Digest of Technical Papers,), p. 185, edited in 1999

[Non-Patent Document 3] T. Yoshihara et al., (SID'00 Digest of Technical Papers,), p. 1176, edited in 2000

### DISCLOSURE OF THE INVENTION

The liquid crystal display device of the field-sequential type has the advantages that the light utilization efficiency is high and the power consumption is small, as compared with the liquid crystal display device of the color filter, as mentioned above. However, in order to further reduce the power consumption and in view of the limit on the drive voltage of a driver IC, the decrease in the drive voltage is required. There is the limit on the drive voltage that can be applied to the liquid crystal material. However, in the driver IC, typically, as its drive voltage is lower, its cost is cheaper. Thus, the decrease in the drive voltage is desired from the viewpoint of the cost.

The requests for the smaller power consumption and decrease in the drive voltage as mentioned above are similar in the liquid crystal display device of the color filter type.

The present invention has been made with the aim of solving the above problems. It is therefore an object of the present invention to provide a liquid crystal display device that can realize the reduction in the drive voltage and consequently attain the small power consumption and also drive the liquid crystal material and attain the drop in a cost even by using a driver IC which has a cheap cost and a low output voltage, and its driving method.

A liquid crystal display device according to a first aspect is a liquid crystal display device in which a liquid crystal material is sealed in gap composed of a plurality of substrates, and which comprises: a switching element for controlling a voltage application to the liquid crystal material, correspondingly to each of a plurality of pixels; and a capacitor connected to the switching element, on the substrate, characterized in that the device includes means for changing one potential of the capacitor, after the voltage application to the liquid crystal material is performed.

A method of driving a liquid crystal display device according to an eighth aspect is a method of driving a liquid crystal display device in which a liquid crystal material is sealed in gap composed of a plurality of substrates, and which comprises: a switching element for controlling a voltage application to the liquid crystal material, correspondingly to each of a plurality of pixels; and a capacitor connected to the switching element, on the substrate, characterized in that, after the voltage application to the liquid crystal material is performed, one potential of the capacitor is changed.

In the first and eighth aspects, after the voltage corresponding to the pixel data is applied to the liquid crystal material of the pixel, one potential of the capacitor (storage capacitor) is changed. Consequently, the distribution of the charges between the storage capacity and the liquid crystal capacity is induced, and the change voltage caused by the distribution of the charges can be applied to the liquid crystal material of the pixel. Thus, the pixel voltage greater than the data voltage through the driver IC can be applied to the liquid crystal material.

The liquid crystal display device according to a second aspect is characterized in that the plurality of pixels are arranged in a matrix form, and one terminal of the capacitor on an N-th line is connected to a gate line of the switching element on an (N-1)-th line.

The liquid crystal display device according to a third aspect is characterized in that a change in a gate voltage on the (N-1)-th line is carried out after a predetermined time elapse since a gate on the N-th line is turned off.

The method of driving the liquid crystal display device according to a ninth aspect is characterized in that the plurality of pixels are arranged in a matrix form, and one terminal of the capacitor on an N-th line is connected to a gate line of the switching element on an (N-1)-th line, and a change in a gate voltage on the (N-1)-th line is carried out after a predetermined time elapse since a gate on the N-th line is turned off.

The second, third and ninth aspects provide the specific manner to change one potential of the capacitor (storage capacitor) in the first and eighth aspects. The circuit structure where one terminal of the capacitor on the N-th line is connected to the gate line of the switching element on the (N-1)-th line is used to change the gate voltage on the (N-1)-th line after the predetermined time elapse since the gate on the N-th line is turned off, and one potential of the capacitor (storage capacitor) is changed. Thus, the pixel voltage can be easily adjusted.

In this case, the predetermined time may be 0. When the predetermined time is assumed to be 0, namely, when the gate voltage on the (N-1)-th line is changed immediately after the gate on the N-th line is turned off, it is possible to surely carry out: the implantation of the charges into the pixel through the driver IC; and the distribution of the charges caused by the change in the gate voltage.

The liquid crystal display device according to the fourth aspect is characterized in that the predetermined time is substantially equal to a time necessary for the voltage application to the liquid crystal material.

In the fourth aspect, after the elapse of the scanning time necessary for one data write in one sub-frame or one frame since the gate on the N-th line is turned off, the gate voltage on the (N-1)-th line is changed. Thus, in the liquid crystal display device where the pixel voltage is decreased in association with the time elapse after the voltage application, the pixel voltage can be increased by scanning only the gate voltage. Hence, the light transmission rate can be improved.

The liquid crystal display device according to a fifth aspect is characterized in that the liquid crystal material is a liquid crystal material having a spontaneous polarization.

In the fifth aspect, the liquid crystal material exhibits the spontaneous polarization. Since the liquid crystal material having the spontaneous polarization is used, the high speed responsiveness becomes possible, thereby obtaining the high moving image display characteristic and carrying out the displaying based on the field sequential type. In particular, since the ferroelectric liquid crystal material whose spontaneous polarization value is small is used, the drive through the switching element such as the TFT and the like becomes easy.

The liquid crystal display device according to a sixth aspect is characterized in that a color displaying is carried out by using a field sequential method.

In the liquid crystal display device according to the sixth aspect, the color displaying is carried out by using the field sequential method for switching the lights of the plurality of colors with time. Thus, the color displaying having the high resolution, the high color purity and the high speed responsiveness is possible.

The liquid crystal display device according to a seventh aspect is characterized in that a color displaying is carried out by using a color filter method.

In the liquid crystal display device according to the seventh aspect, the color displaying is carried out by using the color filter method. Thus, the color displaying can be easily attained.

The liquid crystal display device of the present invention is designed so as to apply the voltage corresponding to the pixel data to the liquid crystal material of the pixel and then change one potential of the capacitor (storage capacitor) in that pixel. Thus, the change voltage associated with the distribution of the charges between the storage capacity and the liquid crystal capacity can be applied to the liquid crystal material of the pixel, and the drive voltage can be decreased. As this result, the smaller power consumption can be attained, and even if the driver IC of the low drive voltage in which the cost is cheap is used, the liquid crystal material can be driven, and the lower cost can be attained.

### BRIEF DESCRIPTION OF THE DRAWINGS

FIG. 1 is a view showing a transmission circuit of a liquid crystal panel;

FIG. 2 is a timing chart showing a data voltage and a gate voltage;

FIG. 3 is a block diagram showing a circuit structure of a liquid crystal display device according to a first embodiment (field sequential type);

FIG. 4 is a schematic cross sectional view of a liquid crystal panel and a back-light in the liquid crystal display device according to the first embodiment;

FIG. 5 is a diagrammatic view showing an overall structure of the liquid crystal display device according to the first embodiment;

FIG. 6 is a view showing an example (half-V-shape characteristic) of an electro-optic response characteristic of a liquid crystal material;

FIG. 7 is a view showing a drive sequence of a liquid crystal display device of an example 1;

FIG. 8 is a timing chart showing a data voltage and a gate voltage of the liquid crystal display device of the example 1;

FIG. 9 is a graph showing a data voltage/transmission light intensity characteristic in the liquid crystal display device of the example 1;

FIG. 10 is a view showing a drive sequence of a liquid crystal display device of an example 2;

FIG. 11 is a timing chart showing a data voltage and a gate voltage of the liquid crystal display device of the example 2;

FIG. 12 is a graph showing a data voltage/transmission light intensity characteristic in the liquid crystal display device of the example 2;

FIG. 13 is a block diagram showing a circuit structure of a liquid crystal display device according to a second embodiment (color filter type);

FIG. 14 is a schematic cross sectional view of a liquid crystal panel and a back-light of the liquid crystal display device according to the second embodiment;

FIG. 15 is a diagrammatic view showing an overall structure of the liquid crystal display device according to the second embodiment; and

FIG. 16 is a view showing a drive sequence of the liquid crystal display device according to the second embodiment.

### EXPLANATION OF REFERENCE NUMERALS

2 Glass Substrate
3 Common Electrode
4 Glass Substrate
13 Liquid Crystal Layer
21 Liquid Crystal Panel
22 Back-Light
31 Control Signal Generation circuit
32 Data Driver
33 Scan Driver
34 Reference voltage Generation circuit
40 Pixel Electrode
41 TFT
42 Data Line
43 Gate Line
44 Liquid Crystal Cell
45 Capacitor
50 Driver unit
60 Color Filter

### BEST MODE OF IMPLEMENTING THE INVENTION

The present invention is specifically explained with reference to the drawings illustrating some embodiments thereof. Note that the present invention is not limited to the following embodiments.

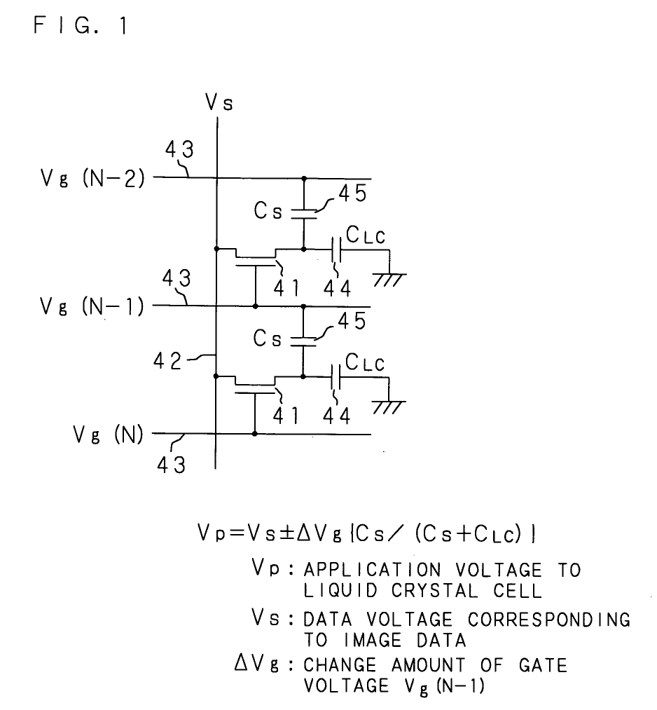

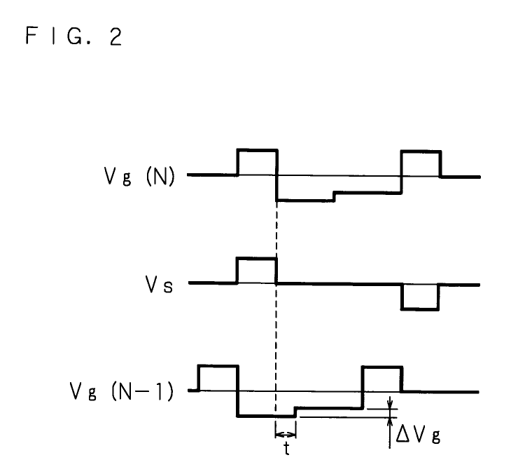

At first, the schema of the present invention is explained by using FIG. 1 and FIG. 2. FIG. 1 is a view showing an equivalent circuit of a liquid crystal panel. On a glass substrate, the combination of a liquid crystal cell 44 (capacity C_{LC}), a TFT 41 and a capacitor 45 (storage capacity Cₛ) constitutes one pixel. The capacitor 45 is installed in order to increase the charge amount to be accumulated in each pixel.

A gate of the TFT 41 on an N-th line is connected to a gate line 43 on an N-th line linked to a scan driver (not shown), and a gate voltage V_{g} (N) to perform an on/off control on the TFT 41 is applied through the gate line 43. Also, a source of the TFT 41 is connected to a data line 42 linked to a data driver (not shown), and a data voltage Vₛ corresponding to a pixel data to be displayed is applied through the data line 42. One terminal of the liquid crystal cell 44 is connected to a drain of the TFT 41, and the other terminal serves as a common potential. One terminal of the capacitor 45 on the N-th line is connected to the gate line 43 on an (N-1)-th line, and the other terminal is connected to a drain of the TFT 41 on the N-th line. The glass substrate used in this liquid crystal panel is the substrate of a Cₛ on-gate type where one terminal of the capacitor 45 on the N-th line is connected to the gate line 43 on the (N-1)-th line.

FIG. 2 is a timing chart showing the data voltage Vₛ and the gate voltages V_{g} (N) and V_{g} (N-1) to explain the driving method of the present invention.

In the present invention, after the data voltage corresponding to a pixel data for displaying is applied to a pixel, one potential of the capacitor 45 is changed. Specifically, after a predetermined time t from the timing when the TFT 41 on the N-th line is turned off by the application of the data voltage Vₛ (the timing when the gate voltage V_{g} (N) is inverted), the gate voltage V_{g} (N-1) is changed by ΔV_{g}. The influence of this ΔV_{g} causes charges to be distributed between the liquid crystal cell 44 (capacity C_{LC}) and the capacitor 45 (storage capacity C_{S}), and the distribution of the charges changes the voltage (pixel voltage Vₚ) applied to the liquid crystal cell 44. The specific value of the pixel voltage Vₚ at this time is represented by the following equation (1).
Vₚ=Vₛ±ΔV_{g}{C_{S}/(C_{S}+C_{LC}} (1)

Thus, a voltage greater than the data voltage Vₛ through the data driver can be applied to a liquid crystal material. Thus, the drive voltage (the data voltage Vₛ of the data driver) can be decreased. Hence, a driver IC that is cheap and has a low output voltage can be used, thereby attaining the drop in a cost. It is noted that the driver IC capable of outputting the voltages of at least 3 values may be used as a scan driver.

The timing when one potential of the capacitor 45 is changed after the TFT 41 is turned off may be the arbitrary timing including the timing immediately after the TFT 41 is turned off. In the case of the change immediately after the gate is turned off (t=0), it is possible to surely carry out the implantation of the charges into the pixel through the data driver and the distribution of the charges associated with the change in the gate voltage. Also, in the case that the potential is changed after the scanning time necessary for one data write in one sub-frame or one frame elapses since the gate is turned off, when the pixel voltage is decreased in association with the time elapse after the voltage application, scanning only the gate voltage can increase the pixel voltage. Thus, the light transmission rate can be increased.

### First Embodiment

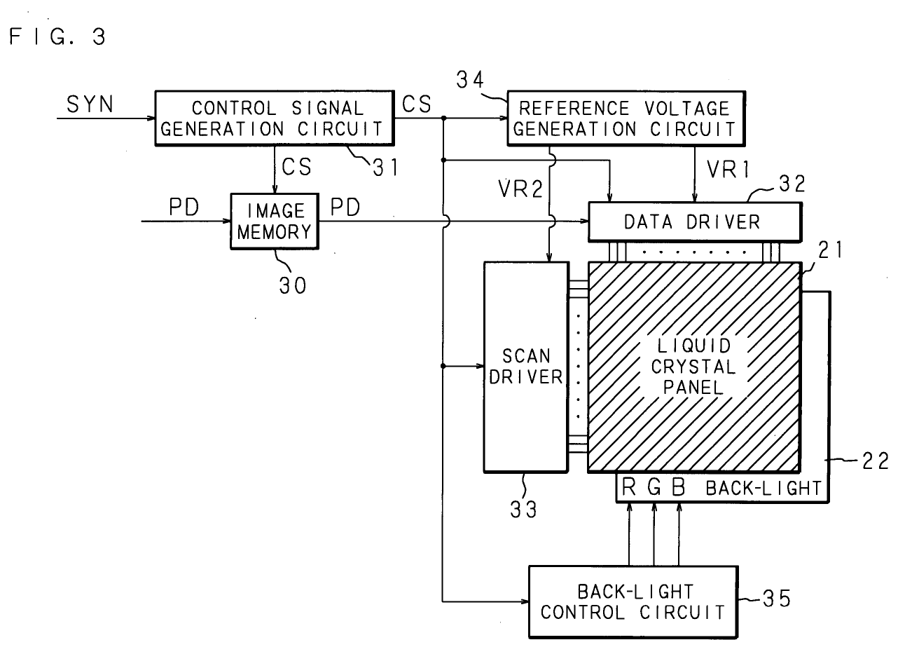

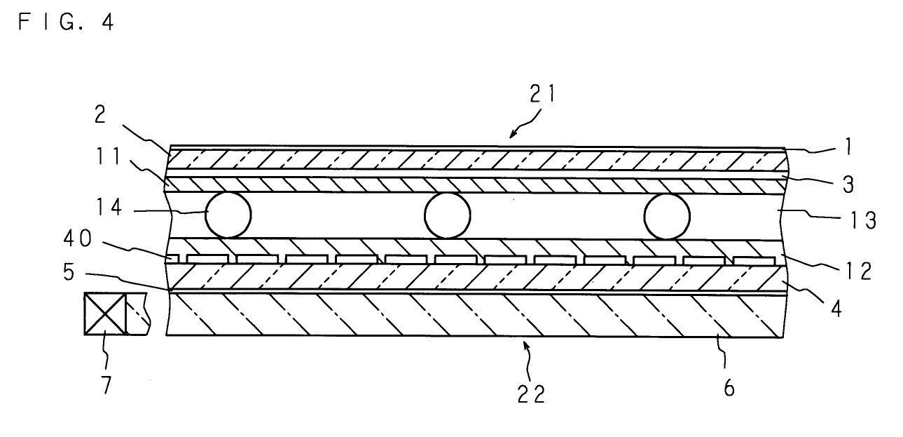

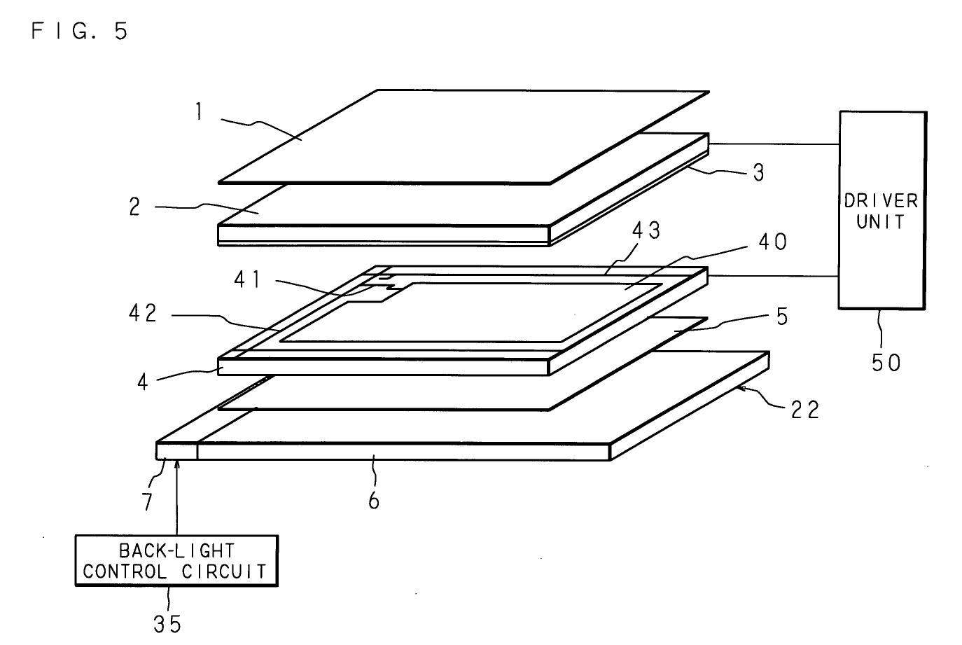

FIG. 3 is a block diagram showing the circuit structure of a liquid crystal display device according to the first embodiment of the present invention. FIG. 4 is a schematic cross sectional view of a liquid crystal panel and a back-light. And, FIG. 5 is a diagrammatic view showing the overall structure of the liquid crystal display device. The first embodiment is the liquid crystal display device that carries out a color displaying by using a field sequential method.

In FIG. 3, the numerals 21, 22 represent a liquid crystal panel and a back-light whose sectional structures are shown in FIG. 4. The back-light 22 is composed of an LED array 7 and a light guiding/diffusing plate 6, as shown in FIG. 4. As shown in FIG. 4 and FIG. 5, the liquid crystal panel 21 is configured such that a polarization film 1, a glass substrate 2, a common electrode 3, a glass substrate 4 and a polarization film 5 are stacked in this order from the upper layer (surface) side to the lower layer (rear) side. Pixel electrodes 40, 40 - - - are arranged in a matrix form on the surface of the common electrode 3 side of the glass substrate 4.

A driver unit 50 that is composed of a data driver 32, a scan driver 33 and the like is connected between the common electrode 3 and the pixel electrodes 40, 40 - - - . The data driver 32 is connected through the data line 42 to the TFT 41, and the scan driver 33 is connected through the gate line 43 to the TFT 41. The TFT 41 is controlled so as to be turned on and off by the gate voltage supplied through the gate line 43 from the scan driver 33. Also, the individual pixel electrodes 40, 40 - - - are connected to the TFT 41. Thus, the transmission light intensity of the individual pixel is controlled by the signal (data voltage) from the data driver 32 that is given through the data line 42 and the TFT 41.

An alignment film 12 is formed on the top surfaces of the pixel electrodes 40,40 - - - on the glass substrate 4, and an alignment film 11 is formed on the bottom surface of the common electrode 3, respectively. Liquid crystal substances are filled between those alignment films 11, 12 so that a liquid crystal layer 13 is formed. It is noted that the numeral 14 represents a spacer for holding a layer thickness of the liquid crystal layer 13.

The back-light 22 is located on the bottom layer (rear) side of the liquid crystal panel 21 and contains the LED array 7 in the situation placed to face the end surface of the light guiding/diffusing plate 6 constituting a light emitting area. This LED array 7 has one or a plurality of LEDs, in which the LED elements for emitting the lights of three primary colors, namely, the respective colors of red, green and blue are defined as one chip, on the surface opposite to the light guiding/diffusing plate 6. Then, in the sub-frames of red, green and blue, the LED elements of red, green and blue are lighted up, respectively. The light guiding/diffusing plate 6 guides the light emitted from each LED of this LED array 7 to its entire surface, and diffuses the light to the top surface, thereby functioning as the light emitting area.

This liquid crystal panel 21 and the back-light 22 where the time division light emission of red, green and blue is possible are stacked on each other. The timing when this back-light 22 is lighted up and the light emission color thereof are controlled in synchronization with the data scanning based on the display data for the liquid crystal panel 21.

In FIG. 3, the numeral 31 is a control signal generation circuit to which a synchronous signal SYN is inputted from a personal computer and which generates various control signals CS necessary for the displaying. An image memory 30 outputs a pixel data PD to the data driver 32. A voltage is applied through the data driver 32 to the liquid crystal panel 21, in accordance with the pixel data PD and the control signal CS for changing the polarity of the application voltage.

Also, the control signal generation circuit 31 outputs the control signal CS to a reference voltage generation circuit 34, the data driver 32, the scan driver 33 and a back-light control circuit 35, respectively. The reference voltage generation circuit 34 generates reference voltages VR1 and VR2 and outputs the generated reference voltages VR1 and VR2 to the data driver 32 and the scan driver 33, respectively. The equivalent circuit of the liquid crystal panel 21 is shown in FIG. 1, as mentioned above. The data driver 32 outputs the signal (data voltage) to the data line 42 of the pixel electrode 40, in accordance with the pixel data PD from the image memory 30 and the control signal CS from the control signal generation circuit 31. In synchronization with the output of this signal, the scan driver 33 sequentially scans the gate line 43 of the pixel electrode 40 for each line. Also, as shown in FIG. 1, one terminal of the capacitor 45 on the N-th line is connected to the gate line 43 on the (N-1)-th line. Then, after the TFT 41 on the N-th line is turned off, the gate voltage V_{g} (N-1) is changed by ΔV_{g}, and its changed voltage is applied to one terminal of the capacitor 45 (FIG. 2). Also, the back-light control circuit 35 applies the drive voltage to the back-light 22 so that red light, green light and blue light are emitted from the back-light 22, respectively.

The operation of the liquid crystal display device will be described below. The pixel data PD for the displaying is inputted from the personal computer to the image memory 30. The image memory 30 once stores this pixel data PD and then outputs this pixel data PD, when receiving the control signal CS outputted from the control signal generation circuit 31. The control signal CS generated by the control signal generation circuit 31 is sent to the data driver 32, the scan driver 33, the reference voltage generation circuit 34 and the back-light control circuit 35. The reference voltage generation circuit 34, when receiving the control signal CS, generates the reference voltages VR1 and VR2 and outputs the generated reference voltages VR1 and VR2 to the data driver 32 and the scan driver 33, respectively.

The data driver 32, when receiving the control signal CS, outputs the signal (data voltage) to the data line 42 of the pixel electrode 40, in accordance with the pixel data PD outputted from the image memory 30. The scan driver 33, when receiving the control signal CS, sequentially scans the gate line 43 of the pixel electrode 40 for each line. In accordance with the signal (data voltage) from the data driver 32 and the gate voltage V_{g} from the scan driver 33, the TFT 41 is driven, and the voltage is applied to the pixel electrode 40, and the transmission light intensity of the pixel is controlled. The back-light control circuit 35, when receiving the control signal CS, supplies the drive voltage to the back-light 22, and performs the time division on the LED elements of the respective colors composed of red, green and blue that are possessed by the LED array 7 of the back-light 22, and the light is generated, and the red light, green light and blue light are sequentially emitted with time. In this way, the lighting-up control of the back-light 22 (the LED array 7) for outputting the incident light to the liquid crystal panel 21 and the plurality of times of data scannings to the liquid crystal panel 21 are made synchronous with each other, and the color displaying is carried out.

The specific examples will be described below.

### EXAMPLE 1

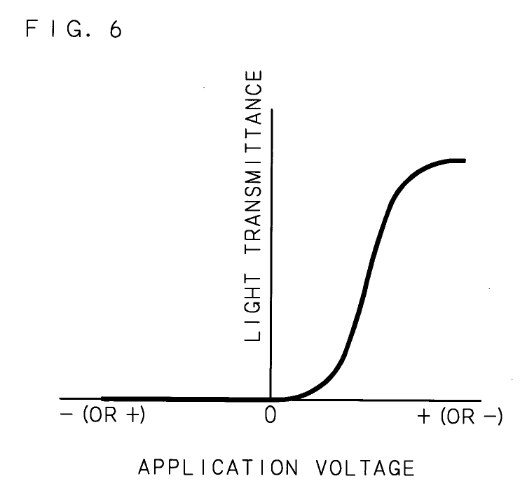

After the TFT substrate having the pixel electrodes 40, 40 - - - (the number of the pixels of 640×480, the diagonal of 3.2 inches) and the glass substrate 2 having the common electrode 3 were washed, polyimide was coated, and they were baked at 200° C. for an hour. Consequently, polyimide films of about 200 Å were formed as the alignment films 11, 12. Moreover, those alignment films 11, 12 were rubbed with a cloth made of rayon, and those two substrates were stacked on each other so that the rubbing directions were parallel. Then, between both of them, they were stacked on each other in the situation that gap was held with the spacer 14 made of silica having an average particle diameter of 1.6 μm, and an empty panel was produced. A ferroelectric liquid crystal material (for example, a material disclosed in A. Mochizuki et al. Ferroelectrics, 133,353 (1991)) whose main component was a naphthalene-based liquid crystal indicating an electro-optic response characteristic of a half-V-shape shown in FIG. 6 was sealed between those alignment films 11, 12 of this empty panel, and the liquid crystal layer 13 was formed. The magnitude of the spontaneous polarization of the sealed ferroelectric liquid crystal material was 10 nC/cm². Also, the value of the storage capacity C_{S} of the capacitor 45 was designed such that the ratio C_{S}/C_{LC} between the liquid crystal capacity C_{LC} and the storage capacity C_{S} in each pixel became approximate 1.0. It was noted that the value of 10 kHz was used as the liquid crystal capacity C_{LC} because the spontaneous polarization had no substantial effect thereon. The produced panel was sandwiched between the two polarization films 1, 5 in crossed-Nicol states, and the liquid crystal panel 21 was defined. Then, when the long-axis direction of ferroelectric liquid crystal molecules was tilted in one way, this was designed so as to be in a dark state.

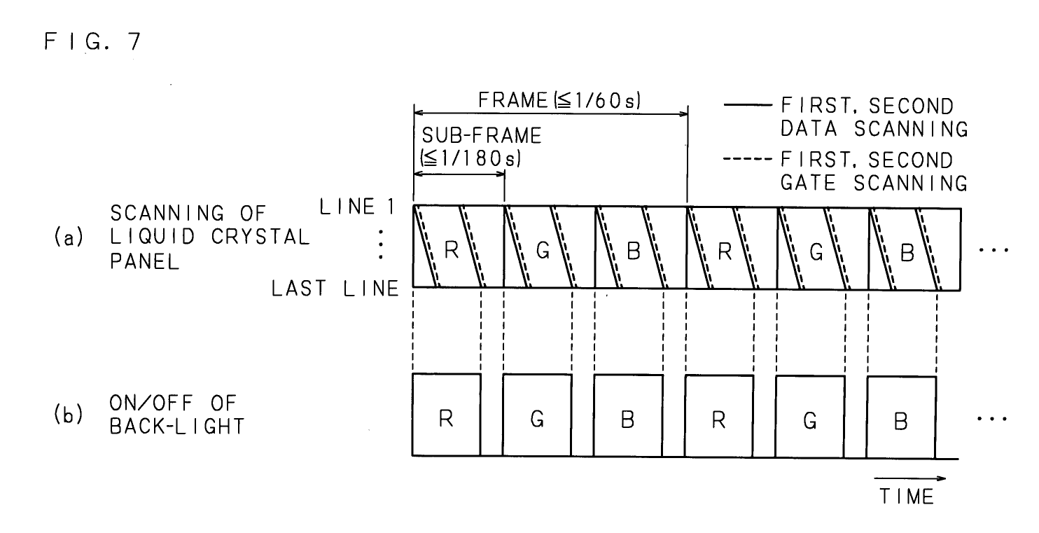

The thus-produced liquid crystal panel 21 and the back-light 22, where the LED array 7 that enabled the monochrome surface light emission switching of red, green and blue was used as the light source, were stacked on each other, and the color displaying based on the field sequential method was carried out in accordance with a drive sequence shown in FIG. 7. A frame frequency was set to 60 Hz, and one frame (period: 1/60 s) was divided into 3 sub-frames (period: 1/180 s), and as shown in FIG. 7(a), for example, in the first sub-frame within one frame, two write scannings of red image data were carried out, and in the next second sub-frame, two write scannings of green image data were carried out, and in the final third sub-frame, two write scannings of blue image data were carried out. In the two data scannings in each sub-frame, at the time of the first (former) data scanning, the voltage on the polarity side from which a bright displaying including 0 V was obtained was applied to the liquid crystal of each pixel on the basis of the pixel data. At the time of the second (latter) data scanning, the voltage whose polarity was opposite to the application voltage at the time of the first data scanning and whose voltage is substantially equal was applied to the liquid crystal of each pixel. As this result, at the time of the second data scanning, the dark displaying that could be regarded as the substantially black image as compared with the first data scanning was obtained.

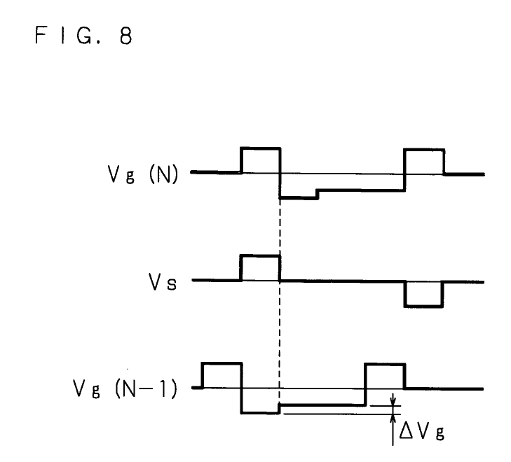

Also, with respect to the first and second data scannings in each sub-frame, as shown in the timing chart of FIG. 8, the gate voltage V_{g} (N-1) on the (N-1)-th line was changed by ΔV_{g} (specifically, 2 V) immediately after the gate on the N-th line was turned off (the first and second gate scannings in FIG. 7(a)). Thus, since the gate voltage is changed immediately after the gate is turned off, it is possible to surely carry out the implantation of the charges into the pixel through the data scanning and the distribution of the charges associated with the change in the gate voltage.

On the other hand, the lighting up of each color of red, green and blue of the back-light 22 was controlled as shown in FIG. 7(b). In each sub-frame, the back-light 22 was lighted up between the start of the first data scanning and the completion of the second data scanning.

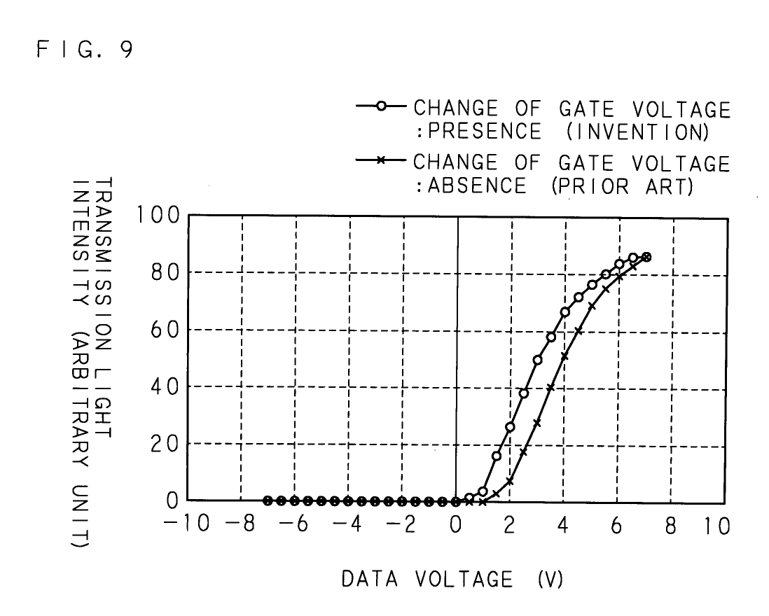

FIG. 9 shows the relation between the transmission light intensity in white displaying and the data voltage when the gate voltage is changed in the example 1 as mentioned above. Also, for the sake of check, FIG. 9 jointly shows even the relation between the transmission light intensity in the white displaying and the data voltage when the foregoing change in the gate voltage is not carried out. From the result of FIG. 9, when the same transmission light intensity is obtained, it is known that the data voltage can be decreased by about 1 V, if the gate voltage is changed.

When an image is displayed under the various displayed states by using the driving method such as the example 1 that changes the gate voltage and the conventional driving method that does not change the gate voltage, the displaying of the high quality, which is excellent in the display color purity, the moving image display characteristic and the resolution degree, can be attained in any driving method.

### EXAMPLE 2

After the TFT substrate having the pixel electrodes 40, 40 - - - (the number of the pixels of 640×480, the diagonal of 3.2 inches) and the glass substrate 2 having the common electrode 3 were washed, the polyimide was coated, and they were baked at 200° C. for an hour. Consequently, the polyimide films of about 200 Å were formed as the alignment films 11, 12. Moreover, those alignment films 11, 12 were rubbed with the cloth made of rayon, and those two substrates were stacked on each other so that the rubbing directions were parallel. Then, between both of them, they were stacked on each other in the situation that the gap was held with the spacer 14 made of the silica having the average particle diameter of 1.6 μm, and the empty panel was produced. A ferroelectric liquid crystal material of a mono-stable type (made by Clariant Japan: R2301) indicating the electro-optic response characteristic of the half-V-shape shown in FIG. 6 was sealed between those alignment films 11, 12 of this empty panel, and the liquid crystal layer 13 was formed. The magnitude of the spontaneous polarization of the sealed ferroelectric liquid crystal material was 6 nC/cm². Also, after it was sealed, a DC voltage of 3 V was applied with a transition point of a Chiral-Smectic C phase from a Cholesteric phase between, and the uniform liquid crystal alignment state is realized (alignment process). Also, in such a way that the ratio C_{S}/C_{LC} between the liquid crystal capacity C_{LC} and the storage capacity C_{S} in each pixel became approximate 1.5, the value of the storage capacity C_{S} of the capacitor 45 was designed. It was noted that the value of 10 kHz was used as the liquid crystal capacity C_{LC} because the spontaneous polarization had no substantial effect thereon. The produced panel was sandwiched between the two polarization films 1, 5 in the crossed-Nicol state, and the liquid crystal panel 21 was formed. Then, when the long-axis direction of the ferroelectric liquid crystal molecules was tilted in one way, this was designed so as to be in the dark state.

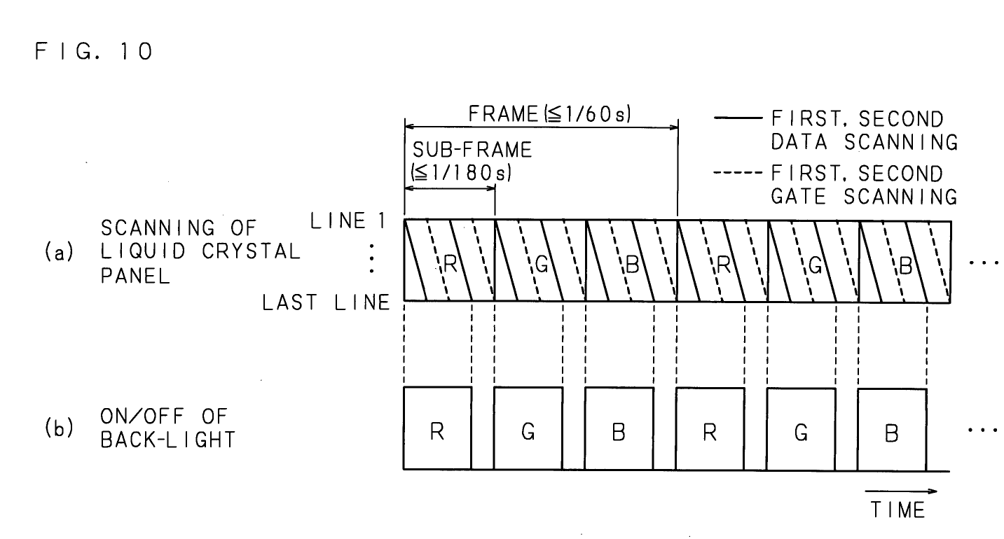

The thus-produced liquid crystal panel 21 and the back-light 22, where the LED array 7 enabling the monochrome surface light emission switching of red, green and blue was used as the light source, were stacked on each other, and in accordance with the drive sequence shown in FIG. 10, the color displaying based on the field sequential method was carried out.

The write scanning of the image data in the example 2 was similar to the case of the example 1 (FIG. 7(a)), and the two write scannings whose polarities were different were carried out in each sub-frame (FIG. 10(a)).

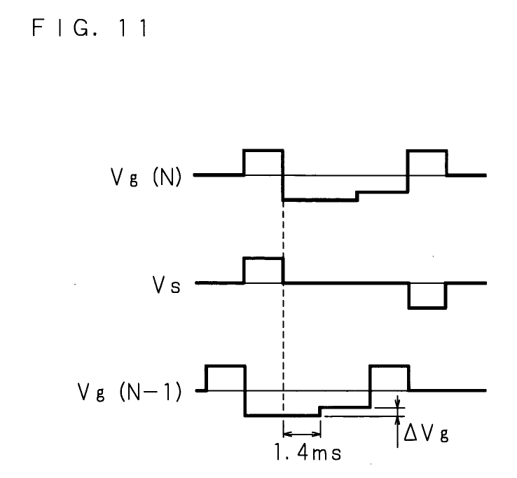

Also, with respect to the first and second data scannings in each sub-frame, as shown in the timing chart of FIG. 11, after the predetermined time since the gate on the N-th line was turned off, the gate voltage V_{g} (N-1) on the (N-1)-th line was changed by ΔV_{g} (specifically, 3 V) (the first and second gate scannings in FIG. 10(a)). In this example, the foregoing predetermined time was assumed to be the time (specifically, about 1.4 ms) necessary for the one data scanning in the sub-frame. Thus, in the liquid crystal display device where the pixel voltage is decreased in association with the time elapse after the voltage application, the pixel voltage can be increased by scanning only the gate voltage. Hence, the light transmission rate can be improved.

It is noted that the time while each color of red, green and blue of the back-light 22 was lighted up was similar to the example 1 (FIG. 7(b)), and it was assumed to be the time between the start of the first (former) data scanning and the completion of the second (latter) data scanning (FIG. 10(b)).

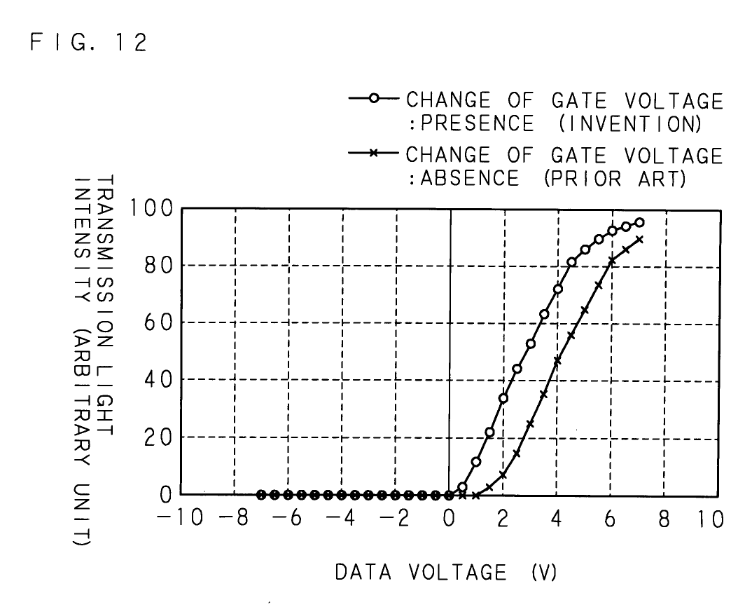

FIG. 12 shows the relation between the transmission light intensity in the white displaying and the data voltage in the case when the gate voltage is changed in the example 2 as mentioned above. Also, for the sake of the check, FIG. 12 jointly shows even the relation between the transmission light intensity in the white displaying and the data voltage in the case when the foregoing change in the gate voltage is not carried out. From the result of FIG. 12, when the same transmission light intensity is obtained, it is known that the data voltage can be decreased by about 1.5 V, if the gate voltage is changed.

When the driving method that changed the gate voltage as described in the example 2 and the driving method that changed the gate voltage as described in the conventional technique were used to display the image under the various display states, any of the driving methods can realize the displaying of the high quality which is excellent in the display color purity, the moving image display characteristic and the resolution degree.

### Second Embodiment

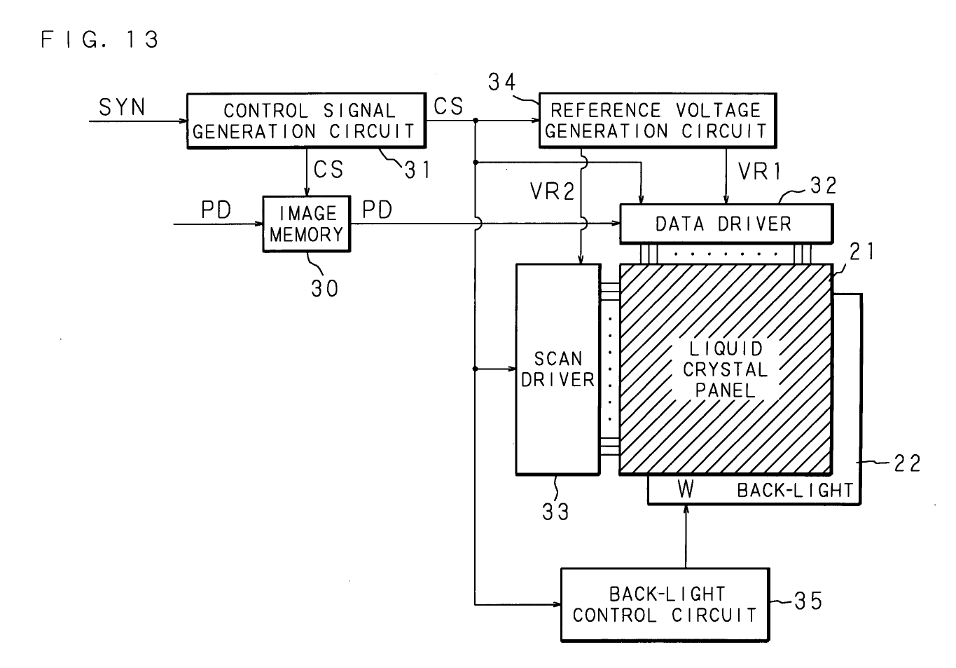

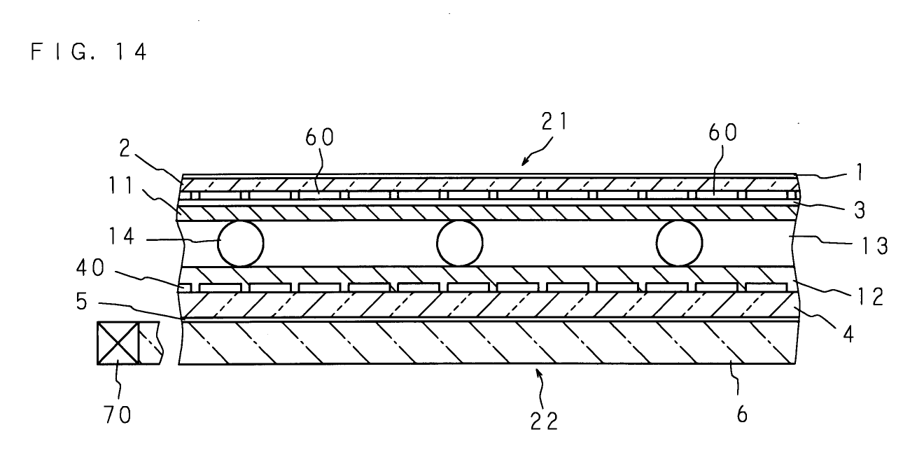

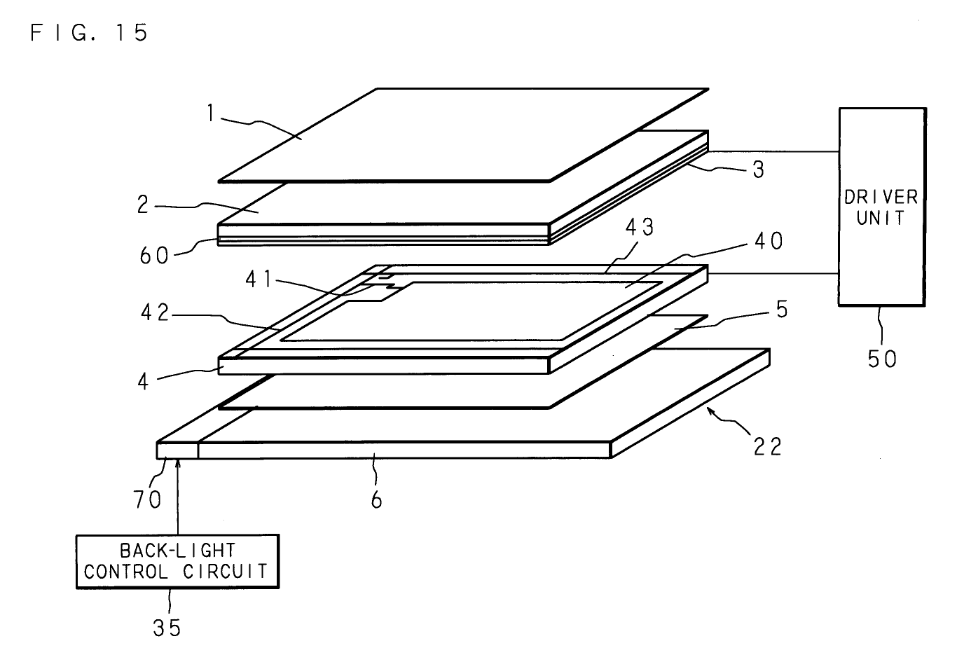

FIG. 13 is a block diagram showing the circuit structure of the liquid crystal display device according to the second embodiment of the present invention. FIG. 14 is a schematic cross sectional view of the liquid crystal panel and the back-light, and FIG. 15 is a diagrammatic view showing the overall structure of the liquid crystal display device. The second embodiment is the liquid crystal display device for carrying out the color displaying based on the color filter method. In FIGS. 13 to 15, the same symbols are assigned to the portions similar to FIGS. 3 to 5.

Color filters 60, 60 - - - for the three primary colors (R, G and B) are installed in the common electrode 3. Also, the back-light 22 is composed of: a white light source 70 containing one or a plurality of white light source elements for outputting white lights; and the light guiding/diffusing plate 6. In the liquid crystal display device of such a color filter type, the white light emission from the white light source 70 which enables the time division light emission of the white light is selectively transmitted through the color filters 60 of a plurality of colors, and the color displaying is carried out.

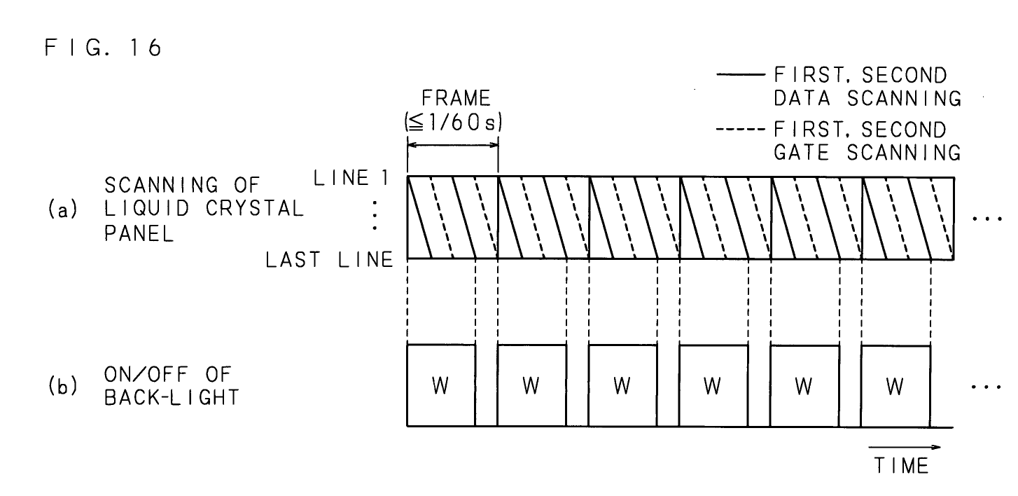

FIG. 16 shows one example of the drive sequence of the liquid crystal display device according to the second embodiment. FIG. 16(a) shows the scan timing of each line in the liquid crystal panel 21, and FIG. 16(b) shows the timing when the back-light 22 is lighted up. As shown in FIG. 16(a), for the liquid crystal panel 21, the two image data write scannings are carried out in each frame. In the first data write scanning, the data write scanning is carried out at the polarity where the bright displaying can be attained, and in the second data write scanning, the voltage whose polarity is opposite to the first data write scanning and whose value is substantially equal is applied.

Also, for the first and second data scannings in each frame, after a predetermined time since the gate on the N-th line is turned off, the gate voltage V_{g} (N-1) on the (N-1)-th line is changed (the first and second gate scannings in FIG. 16(a)). This predetermined time may be 0 such as the example 1 or may be the time (specifically, 4.2 ms) necessary for one data scanning in the frame such as the example 2.

The time while the back-light 22 is lighted up is assumed to be the time between the start of the first (former) data scanning and the completion of the second (latter) data scanning in each frame (FIG. 16(b)).

It is noted that the foregoing example is designed so as to use the TFT substrate of the Cₛ on-gate where the capacitor on the N-th line is connected to the gate line on the (N-1)-th line. However, even the liquid crystal display device having a wiring (bus) peculiar to a capacitor independent of the TFT provides the similar effect, if after the application to the pixel of the data voltage corresponding to the pixel data for the displaying, its wiring (bus) is scanned to adjust one potential of the capacitor (storage capacitor) of its pixel.

Also, the timing when one potential of the capacitor (storage capacitor) is changed after the application to the pixel of the data voltage may be any timing if it is done after the application completion of the data voltage.

Also, the case of using the ferroelectric liquid crystal material exhibiting the spontaneous polarization has been exemplified. However, when another liquid crystal material exhibiting the spontaneous polarization, for example, an anti-ferroelectric liquid crystal material is used, or even when a nematic liquid crystal material that does not exhibit the spontaneous polarization is used, if the drive display method is similar, it is natural that the effect similar to the case of the ferroelectric liquid crystal material can be obtained.

Moreover, the liquid crystal display device of the transmission type has been explained. However, the present invention can be similarly applied to the liquid crystal display device of a reflection type or half-transmission type. In the case of the liquid crystal display device of the reflection type or half-transmission type, the displaying is possible without any use of the light source such as the back-light. Thus, the power consumption is small.

What is claimed is:

1. A liquid crystal display device, comprising:
a plurality of opposite substrates;
a liquid crystal material sealed in gap composed of said plurality of substrates;
a switching element which is installed on said substrate and controls a voltage application to said liquid crystal material, correspondingly to each of a plurality of pixels;
a capacitor which is installed on said substrate and connected to said switching element; and
means for changing one potential of said capacitor, after the voltage application to said liquid crystal material is performed.

2. The liquid crystal display device according to claim 1, wherein the plurality of pixels are arranged in a matrix form, and one terminal of said capacitor on an N-th line is connected to a gate line of said switching element on an (N-1)-th line.

3. The liquid crystal display device according to claim 2, wherein a change in a gate voltage on the (N-1)-th line is carried out after a predetermined time elapse since a gate on the N-th line is turned off.

4. The liquid crystal display device according to claim 3, wherein the predetermined time is substantially equal to a time necessary for the voltage application to said liquid crystal material.

5. The liquid crystal display device according to claim 1, wherein said liquid crystal material is a liquid crystal material having a spontaneous polarization.

6. The liquid crystal display device according to claim 1, wherein a color displaying is carried out by using a field sequential method.

7. The liquid crystal display device according to claim 1, wherein a color displaying is carried out by using a color filter method.

8. A method of driving a liquid crystal display device in which a liquid crystal material is sealed in gap composed of a plurality of substrates, and which comprises: a switching element for controlling a voltage application to said liquid crystal material, correspondingly to each of a plurality of pixels; and a capacitor connected to said switching element, on said substrate, wherein, after the voltage application to said liquid crystal material is performed, one potential of said capacitor is changed.

9. The driving method of the liquid crystal display device according to claim 8, wherein the plurality of pixels are arranged in a matrix form, and one terminal of said capacitor on an N-th line is connected to a gate line of said switching element on an (N-1)-th line, and a change in a gate voltage on the (N-1)-th line is carried out after a predetermined time elapse since a gate on the N-th line is turned off.
